(19) United States
(12) Patent Application Publication
(10) Pub. No.: US 2017/0362365 A1
(43) Pub. Date: Dec. 21, 2017

(54) AMPHIPHILIC COMB POLYMERS CONTAINING METHACRYLIC ANHYDRIDE

(71) Applicants: Dow Global Technologies LLC, Midland, MI (US); Rohm and Haas Company, Philadelphia, PA (US)

(72) Inventors: Charles J. Rand, Philadelphia, PA (US); Kebede Beshah, Harleysville, PA (US); William J. Harris, Lake Jackson, TX (US); Thomas Oswald, Galveston, TX (US); Jeffrey D. Weinhold, Lake Jackson, TX (US)

(21) Appl. No.: 15/535,476

(22) PCT Filed: Dec. 9, 2015
(86) PCT No.: PCT/US15/64720

§ 371 Date: Jun. 13, 2017

Related U.S. Application Data
(60) Provisional application No. 62/095,242, filed on Dec. 22, 2014.

(51) Int. Cl. C08F 230/02; C08L 23/06; C08F 8/32; C08L 67/02; C08F 8/00

(52) U.S. Cl. CPC C08F 230/02; C08L 67/02; C08F 8/00; C08F 8/32; C08L 23/06

(57) ABSTRACT

The present invention provides amphiphilic comb polymer compositions of phosphorus acid group containing backbone polymers of methacrylic anhydride having hydrophobic alkyl, aryl, cycloalkyl or polyolefin ester or amide side chain groups formed on the backbone polymers and comprising from 75 to 100 wt. %, based on the total weight of monomers used to make the backbone polymer, of methacrylic acid polymerized units, wherein in the backbone polymer from 20 to less than 70 wt. %, preferably from 50 to 67 wt. % of the methacrylic acid polymerized units comprise methacrylic anhydride groups as determined by titration of the backbone polymer. As polymeric additives, the polymers can compatibilize polyolefins and polar polymers like polyesters.

The present invention relates to amphiphilic phosphorus acid group containing comb polymers of methacrylic anhydride. More particularly, it relates to amphiphilic phosphate and hypophosphite containing comb polymers of methacrylic anhydride having hydrophobic ester or amide side chains and to methods for making them.

Compatibilization of incompatible resins is often required to provide properties not available in one specific resin. Often the required properties are characteristic of incompatible resins. In such cases, the desired properties may not be realized or other properties of the incompatible blend make the blend of limited use. There is therefore a need to compatibilize various pairs of resins or in some cases more than two resins simultaneously. For example, hydrophobic polymer materials, such as, for example, polyolefins like polyethylene (PE) and polypropylene (PP), and other polymers like polyesters or aqueous emulsion polymer materials can be made compatible by various known methods including corona treatment and use of additives, such as modified core shell rubbers, chlorinated olefins and compatibilizing block or graft copolymers.

In general, compatibilizing polymers have been formed by specialized polymerization or by grafting. However known grafting methods do not provide adequate product grafting densities or graft yields or useful molecular weights and molecular weight distributions; they may require complicated chemistry, such as controlled radical polymerizations, radical graft polymerizations in the melt, epoxide functionalization; or they may require extreme processing conditions, such as long reaction times in the case of controlled radical polymerizations or unusually high temperatures and vacuum assisted water removal. Further, compatibilizing block copolymers are not available for many desirable polymer blends or may be prohibitively expensive to make commercially. Still further, known block copolymers do not enable any chemical binding among the compatibilized mixture, which will yield a more thermally stable compatibilized blend.

U.S. Patent Publication No. 2006/0194053A to Fink discloses the preparation of comb copolymers useful as, for example, dispersing agents by grafting epoxy-functionalized oligomers or polymers, prepared by controlled free radical polymerization (CFRP) on polymers containing groups that can react with epoxides; the resulting process involves making a specific nitrogen terminal group containing polymer/oligomer in the presence of a nitrogen containing epoxy compound and then grafting. Fink fails to provide a clear path to avoiding the specific controlled free radical polymerized polymer or to processing without adding organic solvents or volatile organic compounds (VOCs).

The present inventors have sought to solve the problem of providing a thermally stable, amphiphilic polymers that enhance the compatibility of otherwise incompatible materials and simplified, low VOC or VOC free methods for making them.

### STATEMENT OF THE INVENTION

1. In accordance with the present invention, amphiphilic comb polymers comprise one or more phosphorus acid group, preferably hypophosphite group, containing backbone polymers of methacrylic anhydride having one or more or, preferably, two or more, hydrophobic ester or amide side chains formed on the backbone polymers, wherein the backbone polymers comprise from 75 to 100 wt. %, or, preferably, from 90 to 100 wt. %, or, more preferably, 95 to 100 wt. %, or, most preferably, 99 to 100 wt. %, based on the total weight of monomers used to make the backbone polymer, of methacrylic acid polymerized units, and, further wherein, from 20 to less than 95 wt. %, or, less than 70 wt. %, or, preferably, from 50 to 67 wt. %, or, more preferably, from 60 to 67 wt. % of the methacrylic acid polymerized units in the backbone polymers comprise methacrylic anhydride groups as acid polymerized units, all methacrylic anhydride percentages as determined by titration of the backbone polymer prior to the formation of any ester or amide side chains.

2. In accordance with the amphiphilic comb polymer compositions of item 1, above, the one or more phosphorus acid group containing backbone polymers in the amphiphilic comb polymers of the present invention have a weight average molecular weight (Mw) of from 1,000 to 25,000, or, preferably, 2,000 or more, or, preferably, 15,000 or less, or, more preferably, 10,000 or less.

3. In accordance with the amphiphilic comb polymer compositions of any one of items 1 or 2, above, the one or more phosphorus acid group containing backbone polymers in the amphiphilic comb polymers of the present invention comprise from 1 to 20 wt. %, or 2 wt. % or more, or, preferably, 4 wt. % or more, or, preferably, 15 wt. % or less of a phosphite compound, a hypophosphite compound or its salts, such as, for example, sodium hypophosphite, based on the total weight of reactants (i.e., monomers, hypophosphite compounds and chain transfer agents) used to make the backbone polymer.

4. In accordance with the amphiphilic comb polymer compositions of any one of items 1, 2 or 3, above, the phosphorus acid group containing backbone polymers in the amphiphilic comb polymers comprise the reaction product of less than 2 wt. %, based on the total weight of reactants used to make the backbone polymer, of reactants other than a hypophosphite compound or any monomer other than methacrylic acid or its salt.

5. In accordance with the amphiphilic comb polymer compositions of any of items 1, 2, 3 or 4, above, wherein the backbone polymer comprises at least one cyclic methacrylic anhydride group or from 0.01 to 25 wt. %, or, from 0.1 to 15 wt. %, based on the total weight of the polymer compositions, of one or more hydrophobic group containing alcohol or amine compounds.

6. In accordance with the amphiphilic comb polymer compositions of any of items 1, 2, 3, 4, or 5, above, wherein the hydrophobic ester or amide side chains are chosen from those having an average of from 1 to 500 carbons, cycloaliphatic hydrocarbons having an average of from 1 to 500 carbons, aryl hydrocarbons having an average of from 1 to 500 carbons, polyolefins or their combinations linked to the backbone polymer via an ester or amide group, preferably, C₆ to C₂₅₀ hydrocarbons, or, more preferably, C₆ to C₂₅₀ alkyl hydrocarbons.

7. In accordance with the amphiphilic comb polymer compositions of any of items 1, 2, 3, 4, 5, or 6, above, wherein the phosphorus acid group containing backbone polymers of methacrylic anhydride having hydrophobic side chains comprises powders, pellets, granules, or suspensions thereof in non-aqueous carriers, such as oils, e.g., vegetable oils, glycols, polyglycols, ethers, glycol ethers, glycol esters and alcohols.

8. In another aspect of the present invention, methods for making amphiphilic comb polymers with phosphorus acid group, preferably hypophosphite group, containing backbone polymers of methacrylic anhydride having one or more hydrophobic side chains comprise aqueous solution polymerizing a monomer mixture of one or more phosphorus acid compound and/or its salt and methacrylic acid and/or its salt to form a precursor backbone polymer having methacrylic acid polymerized units, drying the precursor backbone polymer, preferably, under shear, to form a melt of a backbone polymer of methacrylic anhydride, and grafting one or more hydrophobic group containing alcohol or amine compound onto the backbone polymer, the alcohol or amine compound chosen from a C₁ to C₅₀₀ alkyl group containing, preferably, alkyl terminated, alcohol compound, a C₁ to C₅₀₀ alkyl group containing, preferably, alkyl terminated, amine compound, C₁ to C₅₀₀ cycloaliphatic group containing alcohol compound, a C₁ to C₅₀₀ cycloaliphatic group containing amine compound, a C₁ to C₅₀₀ alkyl aryl group containing alcohol compound, a C₁ to C₅₀₀ alkyl aryl group containing amine compound, a polyolefin alcohol compound, and a polyolefin amine compound, preferably, a C₆ to C₂₅₀ fatty alcohol or fatty amine, or, preferably, an alcohol or amine terminated compound, such as a primary alcohol or a primary amine, to form hydrophobic side chains.

9. In accordance with the methods of making amphiphilic comb polymers of item 8, above, wherein the drying of the precursor backbone polymer comprises heating it to a temperature of 175 to 250° C., preferably, 180° C. or more or, preferably, 220° C. or less, or, more preferably, 200° C. or more, to form a melt of the backbone polymer of methacrylic anhydride.

10. In accordance with the methods of making amphiphilic comb polymers of items 8 or 9, above, wherein the drying takes place in an extruder, kneader or kneader reactor, fluid bed dryer, evaporator, heated mixer preferably, an extruder, kneader or kneader reactor.

11. In accordance with the methods of making amphiphilic comb polymers of items 8, 9 or 10, above, wherein in the grafting, the ratio of molar equivalents of alcohol or amine groups, used to esterify or amidate the backbone polymers of methacrylic anhydride, to molar equivalents of carboxyl groups not converted into methacrylic anhydride, based on the total amount of methacrylic acid polymerized units, as determined by titration, ranges from 0.1:1 to 2.0:1 molar equivalents amine or alcohol to molar equivalents of methacrylic anhydride acid polymerized units, or, 1:1 or less, or, preferably, 1.05:1 or less or, preferably, 0.2:1 or more, or 0.5:1 or more. Preferably, either or both of a slight excess of the molar equivalents of alcohol or amine groups used to esterify or amidate the backbone polymers of methacrylic anhydride to molar equivalents of carboxyl groups not converted into methacrylic anhydride or the presence of unreacted alcohol or amine groups, helps to create crystalline hydrophopic side phases in the polymers.

12. In yet another aspect of the present invention, amphiphilic comb polymer compositions comprise one or more phosphorus acid group containing backbone polymers of methacrylic anhydride having one or more hydrophobic side chains and one or more hydrophobic polymer, preferably, a polyolefin such as polyethylene, polypropylene, copolymers of polyethylene, or thermoplastic polyolefins.

13. In accordance with the amphiphilic comb polymer compositions of item 12, above, wherein the compositions comprise a total of from 0.1 to 35 wt. %, or, from 0.1 to 30 wt. %, or, preferably, from 1 to 15 wt. %, of the one or more phosphorus acid group containing backbone polymers of methacrylic anhydride having hydrophobic side chains and one or more hydrophobic group containing alcohol or amine compound.

14. In accordance with the amphiphilic comb polymer compositions of items 12 or 13, above, the compositions further comprising an acrylic emulsion polymer, a polyamide polymer, a polyester polymer, preferably, polyethylene terephthalate, polybutylene terephthalate, or polybutylene adipate, or a polymer which contains a group that reacts with methacrylic anhydride in polymerized form, such as polyvinyl alcohol or vinyl ester copolymers.

As used herein, the term “acid polymerized units” refers to the polymerized form of addition polymerizable carboxylic acids and salts thereof, such as acrylic or methacrylic acid, and includes those carboxylic acids in their anhydride form, e.g., methacrylic anhydride.

As used herein, the term “methacrylic acid polymerized units” refers to the polymerized form of methacrylic acid, its salts or methacrylic acid anhydride, i.e. polymerized methacrylic acid in anhydride form; thus, a single cyclic methacrylic anhydride as acid polymerized units comprises two methacrylic acid polymerized units.

As used herein, the term “based on the total weight of monomers” refers to the total weight of addition monomers, such as, for example, vinyl or acrylic monomers.

As used herein the term “molar equivalent” means for an alcohol or amine compound, the amount of such compound that contains 1 mole of an alcohol (OH) or 1 mole of amine (NHR or NH₂); for example, for hexylamine, it is 101.19 g of hexylamine; for an anhydride group containing compound or acid polymerized unit, the term means the amount of such compound that contains 2 moles of carboxylic acid; for example, for methacrylic anhydride acid polymerized units, it is (˜86 g×2−18 g/mole H₂O) or ˜154 g.

As used herein, the term “molecular weight” or “Mw” refers to a weight average molecular weight as determined by aqueous gel permeation chromatography (GPC) using an Agilent 1100 HPLC system (Agilent Technologies, Santa Clara, Calif.) equipped with an isocratic pump, vacuum degasser, variable injection size auto-sampler, and column heater. The detector was a Refractive Index Agilent 1100 HPLC G1362A. The software used to chart weight average molecular weight was an Agilent ChemStation, version B.04.02 with Agilent GPC-add on version B.01.01. The column set was TOSOH Bioscience TSKgel G2500PWxl 7.8 mm ID×30 cm, 7 μm column (P/N 08020) (TOSOH Bioscience USA South San Francisco, Calif.) and a TOSOH Bioscience TSKgel GMPWxl 7.8 mm ID×30 cm, 13 μm (P/N 08025) column. A 20 mM Phosphate buffer in MilliQ HPLC Water, pH ˜7.0 was used as the mobile phase. The flow rate was 1.0 ml/minute. A typical injection volume was 20 μL. The system was calibrated using poly(acrylic acid), Na salts Mp 216 to Mp 1,100,000, with Mp 900 to Mp 1,100,000 standards from American Polymer Standards (Mentor, Ohio).

As used herein, unless otherwise stated, the term “solid state NMR” stands for nuclear magnetic resonance of a given solid as determined using a Bruker AVANCE™ III 400 MHz (100.62 MHz 13C NMR) wide bore solid state NMR spectrometer (Bruker Corp., Billerica, Mass.) with 4 mm rotor MAS (Magic Angle Spinning) probe. About 100 mg of a tested solid was used without any sample preparation. To obtain the necessary signal to noise for any low level species, about 40,000 acquisitions were signal averaged. A comparison of the signals of methylene carbons corresponding to alcohols and esters or amines and amides in the polymers tested were used for calculating the reacted portion of each alcohol or amine material used to make the give polymer to assure higher precision in the quantitative analysis. As used herein, the term “proton NMR” is as defined in the Examples, below.

As used herein, the term “titration” is as described below in the Examples for determining the methacrylic anhydride proportion and the carboxylic acid or salt proportion in a given backbone polymer of methacrylic anhydride. In any backbone polymer of methacrylic anhydride, the calculated percentage of COOH groups not converted into methacrylic anhydride, based on the total amount of methacrylic acid polymerized units, equals 100% minus the calculated percent of COOH groups that have been converted into anhydride groups.

As used herein, the term “wt. %” stands for weight percent.

All ranges recited are inclusive and combinable. For example, a disclosed temperature of 175 to 250° C., preferably, 180° C. or more or, preferably, 220° C. or less, or, more preferably, 200° C. or more, would include a temperature of from 175 to 180° C., from 175 to 220° C., from 175 to 200° C., from 180 to 250° C., preferably, from 180 to 220° C., preferably, from 180 to 200° C., preferably, from 200 to 250° C., more preferably, from 200 to 220° C., and from 175 to 250° C.

Unless otherwise indicated, all units of temperature and pressure are room temperature and standard pressure.

All phrases comprising parentheses denote either or both of the included parenthetical matter and its absence. For example, the phrase “(meth)acrylate” includes, in the alternative, acrylate and methacrylate.

The present invention provides amphiphilic comb polymer compositions that provide improved compatibility between incompatible materials, wherein the more polar or hydrophilic polymer contains sites that may react with the anhydride and/or carboxylic groups in the inventive amphiphilic comb polymer and the hydrophobic polymer is miscible with the hydrophobic comb chains present in the comb polymer. Thus the hydrophobic chains in the inventive comb polymer are selected to have affinity for the hydrophobic polymer to be compatibilized and are preferably very similar in chemical structure. Thus to compatibilize polyethylene with polyester, the combs chains are preferably linear alkyl molecules. In the alternative, to compatibilize polypropylene with polyester, the comb chains are preferably comprised of propylene monomers. The compositions find use in various applications and provides, simple, cost effective methods for making the comb polymers. Such amphiphilic comb polymers are made from phosphorus acid, preferably, hypophosphite, group containing methacrylic acid polymers that form anhydrides at unusually low temperatures, approximately 30° C. lower than poly(methacrylic acid) (pMAA) polymers prepared in the absence of hypophosphite or its salts. The phosphorus acid group containing methacrylic anhydride backbone polymers of the present invention have hydrophobic side chains, are highly thermally stable, and have a high density of reactive anhydride groups that react with the reactive polymer to yield grafts between the reactive hydrophilic/polar polymer and the inventive amphiphilic comb polymer.

Due to the hydrophobic side chains in the polymers of the present invention, the graft ester or amide will be predominantly at the interface of the reactive polymer and will effectively lower the energy difference between the reactive and hydrophobic polymers and thereby increase the surface area between the two immiscible polymers thereby compatibilizing the materials. Owing to the high grafting yields obtained in making the amphiphilic comb polymers of the present invention, such polymers may be used in much smaller quantities than known compatibilizer polymers. In addition, the methacrylic anhydride backbone polymers that form the amphiphilic comb polymers of the present invention are thermally stable over a broad temperature range and do not readily char or decompose as do the corresponding polymers of methacrylic acid prepared in the absence of a phosphorus acid group, such as a hypophosphite or its salts. Unlike their poly(acrylic acid) (pAA) or pAA anhydride analogues, the phosphorus acid group containing backbone polymers of methacrylic anhydride can be thermally formed without any decomposition.

The amphiphilic comb polymer compositions of the present invention provide compatibilization in a polymer blend via a molecule with a reactive function that can chemically bind with one of the polymers or resins and a second functionality that either reactively couples with the second polymer or resin or is miscible with the second polymer resin. The amphiphilic comb polymers possess anhydride functionality that can react with such resins as polyethylene terephthalate (PET), polyamides, such as poly(ε-caproamide) and Nylon™ polymers (DuPont, Wilmington, Del.), and a second functionality selected to be compatible with a second polymer resin. In particular the second functionality may be a hydrocarbon, such as an oligomeric hydrocarbon chain miscible with polyethylene.

Preferably, the phosphorus acid group containing backbone polymers of methacrylic anhydride comprise two or more ester or amide hydrophobic side chains, such as from two to 100 one or more ester or amide hydrophobic side chains or, more preferably, from 10 to 90 ester or amide hydrophobic side chains.

Preferably, the phosphorus acid group containing backbone polymers of methacrylic anhydride comprise ester or amide hydrophobic side chains as ester groups on from 10 to 50 wt. % or, more preferably, from 10 to 33.3 wt. % of the total methacrylic acid polymerized units in the backbone polymer.

The phosphorus acid group containing backbone polymers of methacrylic anhydride of the present invention have on average at least one phosphorus atom in the backbone polymer that is bound to a carbon atom as a terminal or pendant group. Terminal groups may be a phosphinate or phosphonate, such as a monophosphinate, having a vinyl polymer backbone substituent. The at least one phosphorus atom in the backbone polymer can be bound to two carbon atoms, as a phosphite along the carbon chain, such as a diphosphinate having two vinyl polymer backbone substituents, e.g., a dialkyl phosphinate. The varied structures of such phosphorus acid group containing polymers is described in U.S. Pat. No. 5,294,686, to Fiarman et al.

The phosphorus acid containing backbone polymers of methacrylic anhydride may be chosen from hypophosphite or phosphite group containing polymers of methacrylic anhydride, such as those made from methacrylic acid and phosphite or hypophosphite compound reactants only, phosphite group containing polymers of methacrylic anhydride, hypophosphite group containing copolymers of methacrylic anhydride made with additional vinyl or acrylic monomers, and phosphite group containing copolymers of methacrylic anhydride made with additional vinyl or acrylic monomers.

In accordance with the present invention, the backbone polymers of methacrylic anhydride are formed from aqueous solution polymers made from 60 wt. % more and up to 98 wt. % of methacrylic acid and/or its salts, preferably, 70 wt. % or more, or, more preferably, 80 wt. % or more, and the remainder of one or more phosphorus acid compounds, preferably, hypophosphite or hypophosphite salt compounds, and, if desired, a vinyl or acrylic comonomer, based on the total weight of monomers and reactants including the phosphorus acid compounds, e.g., hypophosphites, that are used to make the backbone polymer.

The phosphorus acid group containing backbone polymers of methacrylic anhydride can comprise copolymers of from 0.1 to 25 wt. %, or, preferably, less than 10 wt. %, based on the total weight of monomers used to make the copolymer, of a vinyl or acrylic comonomer which is resistant to hydrolysis or which can provide desirable flow properties.

Suitable comonomers for use in making copolymers of methacrylic acid useful to make the backbone polymers of methacrylic anhydride of the present invention may be any vinyl or acrylic monomer which is thermally stable such that a homopolymer of the monomer having a weight average molecular weight of 50,000 would lose less than 5 wt. % of its weight corresponding to polymer degradation at 250° C. after 10 minutes as determined by thermogravimetric analysis (TGA). Such comonomers are, preferably, methacrylamide, C₁ to C₆ alkyl (meth)acrylamides, C₁ to C₆ dialkyl (meth)acrylamides, styrene and alpha-methyl styrene, and C₁ to C₆ alkyl methacrylates, such as, for example, methyl methacrylate and ethyl acrylate and, if used, preferably, methyl methacrylate.

As for comonomer proportions suitable for use as poly(methacrylic acid) starting materials for use in making backbone polymers of the present invention, adding too much of any comonomer which is not water soluble, such as styrene, will result in a monomer mixture may be difficult to solution polymerize or which exhibits sluggish reaction kinetics. If one uses too much of any comonomer, one cannot achieve a sufficiently high proportion of methacrylic anhydride groups and may not achieve the corresponding thermal stability or advantageous reactivity conferred by such anhydride groups.

Carboxylic anhydrides of methacrylic acid can form from the acidic functions of neighboring methacrylic acid polymerized units along a single polymer chain, from acidic functions of distal acidic polymerized units along a single polymer chain (backbiting), or from acidic functions of separate polymer chains (crosslinking). Preferably, the methacrylic anhydrides are cyclic and form from neighboring methacrylic acid polymerized units along a single polymer chain.

In accordance with the present invention, phosphorus acid, preferably, hypophosphite group, containing backbone polymers of methacrylic anhydride can be prepared by phosphorus acid chain transfer polymerization, for example, hypophosphite chain transfer polymerization of methacrylic acid (MAA) by conventional aqueous solution polymerization methods in the presence of a hypophosphite compound or its salt, followed by drying them at a temperature of 175° C. or higher, and up to 250° C., preferably, 180° C. or higher, and, preferably, 220° C. or less, preferably, with drying while under shear. Drying times are shorter at higher temperatures and generally range from 2 minutes to 8 hours, preferably, 10 minutes or more, or, preferably, 2 hours or less, more preferably, 15 to 75 minutes. In the case where initial drying is followed by heating, such as spray drying and further heating, the further heating takes place at the above recited temperatures for a period of from 5 minutes or more, or, up to 90 minutes, preferably, 70 minutes or less, more preferably, 10 to 60 Minutes.

Suitable phosphorus acid group containing compounds for use in making phosphorus acid group containing backbone polymers of methacrylic anhydride include, for example, phosphorous +1 compounds, for example, hypophosphite compound or its salt, such as sodium hypophosphite; phosphorus +2 compounds, such as, a phosphonate compound, for example, phosphonic acids or their inorganic salts or ammonium, e.g., alkali(ne earth) metal salts; phosphorus +3 compounds, such as C₁ to C₄ dialkyl or trialkyl or phenyl phosphites or diphenyl phosphites; and orthophosphorous acid or salts thereof.

The phosphorus acid, preferably, hypophosphite, group containing backbone polymers of methacrylic anhydride can be prepared several known methods. Suitable drying methods may include, for example, extrusion, such as in a single-screw or twin-screw extruder; kneading, such as in a single shaft or twin-shaft kneader reactor, banbury mixer, or a Buss-Kneader Reactor or Single screw reciprocating extruder/mixer; evaporation, such as in a wiped film evaporator or falling film evaporator vessel; heated mixing, such as in a continuous stirred tank reactor (CSTR) or single and twin-rotor mixers, for example, PLOUGHSHARE™ Mixers (Littleford Day Inc., Florence, Ky.), double arm mixers, sigma blade mixer, or vertical high intensity mixer/compounders; and spray drying or fluid bed drying, coupled additional higher temperature drying, such as drum dryers or belt dryers.

Preferably, to provide backbone polymers of methacrylic anhydride containing at least one cyclic anhydride, the backbone polymers of the present invention are made to comprise only up to about 69 wt. %, for example, 66 to 66.7 wt. %, of methacrylic anhydrides as acid polymerized units, based on the total amount of methacrylic acid polymerized units. Such polymers are generally linear and comprise less than 3 wt. % of anhydrides formed via backbiting or crosslinking. Preferably, such polymers are formed by dehydrating in the absence of shear or in a low shear extruder equipped with a devolatilizing zone.

Low shear extruders may comprise any having at least one low shear zone that expands in a direction transverse to the rotational axis of the extruder screw(s) and in a direction away from any devolatilizer in the low shear zone, any having a barrel with flights for biasing the melt toward the end of the barrel, single screw extruders, co-rotating twin-screw extruders and counter-rotating twin screw extruders, as well as extruders having more than one of these features such as single screw extruders having at least one zone that expands in a direction transverse to the rotational axis of the extruder screw(s) and in a direction away from any devolatilizer in the low shear zone or single screw extruders having a barrel with flights for biasing the melt toward the end of the barrel.

Preferably, a devolatilizing extruder containing one or more devolatilizing zones is used to dry the precursor backbone polymer of the present invention and the fill level in the devolatilizing zone is less than 100% full and is operated in a manner such that there is less than or zero gauge pressure. This minimizes the risk of solid material leaving the screw channels and operates at a pressure such that any residual water volatilizes out of the extruder and results in advancing the equilibrium reaction to form additional anhydride functional groups along the polymer backbone.

The amphiphilic phosphorus acid group containing comb polymers of the present invention can readily be manipulated to tune their hydrophobicity and hydrophilicity for specific attributes. This can be done by altering the grafted fatty alcohol/amine length and the grafting density, with longer chains. This can be done by increasing side chain grafting density leading to increased hydrophobicity. Grafting density can be tuned, for example, for specific applications such as capstocks, films or surface treatments for plastics that enable improved adhesion of acrylic emulsion coatings thereto.

The amphiphilic phosphorus acid group containing comb polymers of the present invention may also be formed from a variety of side chain materials, including, for example, amine terminated polyolefins and fatty alcohols or amines.

The hydrophobic side chains that make up the amphiphilic comb polymers of the present invention may include one or a distribution of chain lengths, and may be chosen from one or more hydrophobic group containing alcohol or amine compound, such as any containing terminal alcohol or amine groups, preferably, a primary alcohol or primary amine compound. The alcohol or amine compound may contain a specific number of carbon atoms or may be a distribution of hydrocarbons with an average of from 1 to 500 carbons, or, preferably, from 6 to 250 carbons, such as alkyl groups, cycloaliphatic groups, or aryl groups, preferably, C₁ to C₅₀₀ fatty alcohols or fatty amines having a or, preferably, a C₆ to C₂₅₀ alkyl group. Other suitable alcohol or amine compounds may be olefinic alcohols or amines, and amine terminated block copolymers or oligomeric olefins terminated with an alcohol or amine; anilines or cyclohexylamines, preferably, amine or alcohol terminated polyolefins. Further, such alcohol or amine compounds having C₁ to C₅₀₀ or, preferably, C₆ to C₂₅₀ groups can contain a cycloaliphatic or aryl groups along a hydrocarbon chain or as a pendant group on a hydrocarbon chain, for example, diphenylpropanolamines or diphenylpropanols.

Examples of polyolefin side chain forming materials may include amine terminated polyolefins where the polyolefin is, for example, polyethylene, an ethylene/alpha-olefin copolymer wherein the alpha-olefin is butene or a higher alpha-olefin, or a block copolymer or a pseudo-block copolymer as described in any of U.S. Pat. Nos. 7,608,668, 7,947,793, or 8,124,709, polypropylene, ethylene/propylene copolymers or block copolymers or pseudo block copolymers, as described in any of U.S. Pat. No. 8,106,139, or U.S. Pat. No. 8,822,599.

The amphiphilic comb polymers of the present invention may be formed from a methacrylic anhydride group containing backbone polymer by reacting it with a hydrophobic group containing alcohol or amine compound, such as a fatty alcohol or amine. The reactivity of the phosphorus acid group containing methacrylic anhydride backbone polymers enables ready side chain formation in a heated melt or mixture of backbone polymer and hydrophobic group containing reactant alcohols or amines.

Residual heat from making the backbone polymers of the present invention is more than sufficient to drive the reaction to form esters or amides and make amphiphilic polymers having hydrophobic side chains and, in addition, methacrylic anhydride groups as acid polymerized units, preferably, cyclic methacrylic anhydride groups. Esterification or amidation needs no added heat and may be formed from a backbone polymer of methacrylic anhydride which has been dried and is still at a temperature of 100 to 240° C. and the indicated alcohol and/or amine. Amines can form amides at room temperature as well as at temperatures of up to 240° C., preferably, up to 160° C.

Only one or more methacrylic anhydride groups as acid polymerized units on the backbone polymers is reacted to esterify or amidate it; thus, one or more methacrylic anhydride groups as acid polymerized units remains on the backbone polymers of the present invention after amidation or esterification.

The hydrophobic ester or amide side chains on the backbone polymers of methacrylic anhydride of the present invention can be formed, respectively, into anhydride or imide functional groups. After esterification in any backbone polymer of methacrylic anhydride, the resulting polymer may be heated to, from 160 to 250° C. to ring close the acid with any neighboring methacrylic acid polymerized units on the backbone polymers to form, respectively, cyclic anhydride functionality.

Reaction of anhydride groups in the backbone polymers of methacrylic anhydride with amine to form amides or imides may be done in solution phase or in melt phase. To form imides, if the amide is formed in solution phase, the reaction is preferably done stepwise by reacting with amine to form amic acid at about room temperature, followed by ring closing to form an imide by heating to 100 to ° C. or higher, depending on the solvent, up to 250° C. A ring closing agent, such as acetic anhydride with a base catalyst such as 3-picoline, may be used separately or in conjunction with thermal ring closing.

The phosphorus acid group containing amphiphilic polymers of the present invention may be also made by partially esterifying a methacrylic acid polymer, e.g., spray dried polymethacrylic acid, at anywhere from room temp up to 140° C., and then heating the esterified product to temperatures sufficient to ring close (160 to 250° C.) some or all of the remaining carboxylic groups and yield anhydride functionality on the backbone polymer.

A hydrophobic group containing alcohol or amine will be preferentially esterified (or amidated) with the anhydrides of polymethacrylic acid/anhydride backbone polymers containing less than 100% anhydride groups, for example, from 10 to 70 wt. % of methacrylic anhydride as polymerized units, based on the total number of methacrylic acid polymerized units in the backbone polymer, as determined by titration.

Preferably, the amount of alcohol or amine, as molar equivalents (1 mole of monoalcohol or monoamine (e.g., hexylamine) means 1 molar equivalent of such alcohol (OH) or amine (NH₂)), used to esterify, amidate the backbone polymers of methacrylic anhydride is, preferably, equal to or less than that required to react with all of the acid polymerized units of methacrylic acid having an anhydride group in a given backbone polymer of methacrylic anhydride, for example, from 0.1:1 to less than 1:1 molar equivalents amine or alcohol to molar equivalents of methacrylic anhydride acid polymerized units, or, preferably, 0:95:1 or less or, preferably, 0.2:1 or more, or 0.5:1 or more.

Excess amine or alcohol to improve ester or amide yield and can be stripped out after reaction.

In accordance with the present invention, compositions of the amphiphilic comb polymers of the present invention comprise one or more polymer and from 0.1 to 30 wt. %, or, preferably, from 1 to 15 wt. %, or up to 8 wt. % or, preferably, up to 4 wt. % of the amphiphilic polymers of the present invention, based on the total weight of polymer solids of the composition. Such polymers may be polar polymers, such as polyamides, polyurethanes or polyesters; or they may be polyolefins, such as polyethylene and polypropylene, block copolymers, pseudo-block copolymers as described in any of U.S. Pat. Nos. 7,608,668, 7,947,793, or 8,124,709, ethylene-propylene copolymers; or they may be mixtures thereof.

The amphiphilic comb polymers of the present invention find many uses, for example, as compatibilizers for incompatible materials, such as, for example, mixtures of polar polymers and polyolefins, like polyesters and olefin polymers, any of polyvinyl alcohols, such as PVOH, vinyl ester copolymers, like EVA, and olefin polymers, urethanes and olefin polymers, acrylics and olefin polymers, or polyamides and olefin polymers.

In one aspect, the compositions of the present invention can comprise one or more polyolefins, such a polyethylene or thermoplastic polyolefins (TPO) and the amphiphilic comb polymers of the present invention as an additive in the polyolefin, a capstock, a film layer or a tie layer to improve the adhesion of polar polymers or coatings containing polymers to the polyolefins. The amphiphilic comb polymers in such compositions increase the surface energy of the polyolefins, thereby improving the adhesion of coatings, like acrylic, polyester, polysiloxane or urethane coatings, thereto. The polymers of the present invention can be added to polymers to increase adhesion to polyolefins.

One composition of the present invention comprises the amphiphilic comb polymers of the present invention containing hydrocarbon hydrophobic side chains and a polyolefin, such as polyethylenes (PE). The amphiphilic comb polymers in such compositions boost the modulus of the polyolefin when the composition comprises from 0.1 to 30 wt. % of the amphiphilic polymers, based on the total weight of polymer solids of the composition. This is desirable in transportation, packaging and other markets where a certain level of rigidity is required. By boosting the modulus of the polymer system, the structure may be downgauged thus allowing the use of less polymer to achieve the same level of rigidity. Suitable polyolefins in such a composition may include HDPE, low density PE (LDPE), and linear low density PE (LLDPE). Examples: The following examples illustrate the present invention. Unless otherwise indicated, all parts and percentages are by weight and all temperatures are in ° C.

Test Methods:

In the Examples that follow, the following test methods were used:

Titration:

The number of methacrylic acid polymerized units or anhydride groups present or produced on a given polymer as a percentage of total polymethacrylic acid units in the polymer was determined. First, the total free carboxylic acid content was measured by hydrolysis of the anhydride. A 0.1-0.2 g of each material was measured and put in a 20 ml glass vial. To this, 10 ml of deionized (DI) water was added and the closed vial was heated in 60° C. oven for 12 h. After 12 h, the vial was titrated against 0.5 N KOH (aq.) to determine acid number of the thus hydrolyzed polymethacrylic anhydride polymer (the total free carboxylic groups in the polymer). Next, the anhydride content was determined by reacting the same pMAAn material in its unhydrolyzed state with methoxy propyl amine (MOPA). MOPA opens the anhydride and reacts with one side, the other side is converted back to a carboxylic acid. For each polymer tested, 0.1-0.2 g of each pMAAn material along with 10 ml of tetrahydrofuran (THF) and 0.2-0.3 g of MOPA was added to a 20 ml glass vial equipped a with magnetic stirrer bar. The vial was closed and the mixture was stirred at room temperature overnight (about 18-20 h). Following this 10 ml of DI water was added and mixture was titrated against 0.5 N HCL (aq.) to determine the anhydride content. Titration was used to determine the overall disappearance of carboxylic acid in the polymer which indicates the conversion of carboxylic acid groups to anhydride. The calculated percentage of COOH (acid groups) converted into anhydride=(mols of anhydride in 1 g of polymer sampled)/(Total mols of —COOH in 1 g of hydrolyzed polymer sampled)*100. Instrument: Titralab™ TIM865 Titration Manager (Radiometer Analytical SAS, France); Reagents: 0.5 N KOH. 0.5 N HCl, Tetrahydrofuran (Sigma Aldrich. St Louis, Mo.).

Proton NMR:

Unless otherwise specified, to determine the esterification yield, a ¹H NMR (Bruker 500 MHz NMR spectrophotometer, Bruker Corp., Billerica, Mass.) technique with water suppression was used for each indicated copolymer. The copolymers with octadecanol alcohol side chains were insoluble in any one solvent; therefore, blends of solvent were used for NMR characterization, including deuterated THF and water (1:1 vol. basis) blend was used as media for NMR experiments. Some specific peaks could be used to calculate yields and amounts of specific functional groups. For example, the relative area under any peak at 4.1 ppm (ester peak) was used to calculate the percentage conversion to esters as compared to the corresponding alcohol peak at proton peaks from octadecanol (area under peaks 0.6 ppm to 3.8 ppm) minus the proton peaks associated with THF (3.58 ppm, 1.73 ppm).

Solid State NMR:

The product of Example 6 was not soluble in THF/Water so a BRUKER™ AVANCE III solid state NMR spectrometer with 4 mm rotor MAS probe was used. About 100 mg of the solid was used without any sample preparation. In order to obtain the necessary signal to noise for the low level species, about 40000 acquisitions were signal averaged. A comparison of the signals of methylene carbons of the alcohol and ester were used for the calculation of the reacted component in order to assure higher precision in the quantitative analysis.

### SYNTHESIS EXAMPLE 1: METHACRYLIC ANHYDRIDE GROUP CONTAINING POLYMERS WITH OCTADECANOL (C₁₈) HYDROPHOBIC SIDE CHAINS

A 5,000 Mw hypophosphite pMAA solution homopolymer of 42 wt. % solids was dried at 150° C. for 1.5 hours. The dried pMAA was pulverized and put in an oven at 200° C. for 30 minutes to convert to the anhydride. Previous methacrylic anhydride group containing polymers made in this way contain from 55 to 60 wt. % of the methacrylic acid polymerized units in the form of anhydride groups. See U.S. Patent Publication No. 2014/0323743 to Rand. Then, 60.5 grams of octadecanol (99% w/w, Aldrich Chemicals, St. Louis, Mo.) and 40.0 g (100% solids) of the polymethacrylic anhydride polymer were charged to a 500 mL 3-neck flask equipped with a with stirrer, thermocouple, and a condenser under a slight N₂ gas blanket. A Jack-o-matic™ stand (Glas-Col, Terre Haute, Ind.) and heating mantle was used to heat the reactor. The slight nitrogen blanket was put on the reactor and the mixture was heated, with stirring initiated when the octadecanol melted. The reaction was carried out at 160° C. for 5 hours then cooled to 80° C. and poured out of the flask; the esterified product contained 33.7% of methacrylic acid polymerized units esterified, as determined by NMR. Perfect 100% yield would have been at 50% esterification.

### SYNTHESIS EXAMPLE 2: METHACRYLIC ANHYDRIDE GROUP CONTAINING POLYMERS WITH OCTADECANOL (C₁₈) HYDROPHOBIC SIDE CHAINS

54.52 grams of octadecanol (99% w/w, Aldrich Chemicals) and 60.0 g of a 100 wt. % solids polymethacrylic anhydride from synthesis Example 1 were charged to a 500 mL 3-neck flask equipped with a stirrer, thermocouple, and a condenser under a slight N₂ gas blanket. A Jack-o-matic™ stand (Glas-Col, Terre Haute, Ind.) and heating mantle was used to heat the reactor. A slight nitrogen blanket was put on the reactor and the mixture was heated, with stirring initiated when the octadecanol melted. The reaction was carried out at 160° C. for 5 hours after reaching temperature then cooled to 80° C. and poured out of the flask. Yield: 21.29% esterification as determined by NMR. Perfect yield would have been at 30% esterification.

### COMPARATIVE SYNTHESIS EXAMPLE 3: METHACRYLIC ACID POLYMERS WITH OCTADECANOL (C₁₈) HYDROPHOBIC SIDE CHAINS

50.62 grams of octadecanol (99% w/w, Aldrich Chemicals) and 140.0 g of a hypophosphite group containing polymethacrylic acid (pMAA) having an Mw of 5,000 (solids ˜42 wt. %) were charged to a 500 mL 3-neck flask equipped with a stirrer, thermocouple, and a condenser under a slight N₂ gas blanket. A Jack-o-matic™ stand (Glas-Col, Terre Haute, Ind.) and heating mantle was used to heat the reactor. The slight nitrogen blanket was put on the reactor and the mixture was heated, stirring was initiated when the octadecanol melted. At 106° C., the material separated into two phases, with one being a partly dry, viscous polyacid on the bottom and the other being liquid octadecanol on the top. At this point the reaction was stopped as the mixture was no longer processable. No material could be evaluated for target esterification, thus yield was effectively 0%. Perfect yield would have been at 30% esterification of acid groups.

### COMPARATIVE SYNTHESIS EXAMPLE 4: METHACRYLIC ACID POLYMERS WITH OCTADECANOL (C₁₈) HYDROPHOBIC SIDE CHAINS

63.99 grams of octadecanol (99% w/w, Aldrich Chemicals) and 80.0 g of spray dried hypophosphite group containing polymethacrylic acid (pMAA) having an Mw of 5,000 (Spray dried, solids ˜90 wt. %) were charged to a 500 mL 3-neck flask equipped with a stirrer, thermocouple, and a condenser under a slight N₂ gas blanket. A Jack-o-matic™ stand (Glas-Col, Terre Haute, Ind.) and heating mantle was used to heat the reactor. The slight nitrogen blanket was put on the reactor and the mixture was heated, stirring was initiated when the octadecanol melted. The reaction was carried out at 160° C. for 5 hours after reaching temperature then cooled to 80° C. and poured out of the flask. Yield: 1.32% esterification as determined by NMR. Perfect yield would have been at 30% esterification.

### SYNTHESIS EXAMPLE 5: METHACRYLIC ANHYDRIDE GROUP CONTAINING BACKBONE POLYMER WITH 66.7 WT. % OF METHACRYLIC ANHYDRIDE GROUPS

Spray dried hypophosphite group containing polymethacrylic acid having an Mw of ˜5K was heated under vacuum (pressure 17 mm Hg). for 4 hrs. at 200° C. The spray dried material melted at about 185° C. and the melt is not agitated during the dehydration process. After cooling under vacuum the now solid mass is crushed and stored in anhydrous conditions. The resulting backbone polymer material has 66.7% of the methacrylic acid polymerized units converted to anhydride, as determined by titration. The resulting material contains equal moles of anhydride functionality and carboxylic acid functionality.

### SYNTHESIS EXAMPLE 6: METHACRYLIC ANHYDRIDE GROUP CONTAINING POLYMERS WITH A DISTRIBUTION OF HYDROPHOBIC SIDE CHAINS HAVING AN AVERAGE 50 CARBON ALKYL LENGTH

102.68 grams of Unilin™ 700 alcohols having an average length of about C₅₀ alkyl alcohols (Baker Hughes, 100% solids) and 44.45 g of a 100 wt. % solids polymethacrylic anhydride prepared in the same manner as Synthesis Example 1 were charged to a 500 mL 3-neck flask equipped with a stirrer, thermocouple, and a condenser under a slight N₂ gas blanket. A Jack-o-matic™ stand (Glas-Col, Terre Haute, Ind.) and heating mantle was used to heat the reactor. A slight nitrogen blanket was put on the reactor and the mixture was heated, with stirring initiated when the Unilin™ 700 alcohol melted. The reaction was carried out at 180° C. for 2 hours after reaching temperature then cooled to 80° C. and poured out of the flask. Yield: 10.8% esterification as determined by solid state NMR. Perfect yield would have been 30% esterification of the anhydride groups in the polymethacrylic anhydride.

### EXAMPLE 7: COMPATIBILIZATION OF POLYESTER/POLYETHYLENE (PET/PE) BLEND

A Haake PolyLab System™ (Model P300) mixer (Thermo Fisher Scientific, Tewksbury, Mass.) was used comprising control of temperature and rotor speed and made up of a Haake Rheomix™ 600 P mixer fitted with a R600 bowl (120 ml chamber volume, excluding rotors; about 65 ml volume with rotors installed), in turn fitted with co-rotating (Rheomix™ 3000E) roller rotors (Thermo Fisher Scientific) geared at a 3:2 ratio, a Haake Rheocord™ used to measure the torque established between the rotors, and a Polylab™ Monitor V 4.18 control software provided as part of the system and used to control rotor speed, temperature and record torque, equipment and melt temperature. A mixing bowl was made of 301 stainless steel—DIN 1.4301 (2014) (SS-301, AK Steel Corp., West Chester, Ohio); the rotors were made of 316 stainless steel—DIN 1.4408 (2014)(SS-316, AK Steel Corp.). All experiments were done with nitrogen padding.

Materials used included a polyester: Eastapak™ 9921 polymer (Eastman, Kingsport, Tenn.); and a polyethylene: DOWLEX 2045 polymer (Dow Chemical, Midland, Mich.).

For each experiment, the total weight of material added to the mixing bowl was 50 g. In each case, the PET and PE were of equal weight and were obtained in pellet form. Each mixture of PET and PE was weighed and shaken to mix and fed to the Haake bowl with the rotors rotating at 2 RPM and the bowl temperature at 265° C. The rotor speed was increased up to 10 RPM approximately every 30 seconds after the addition of polymer in the following incremental amounts: 2, 4, 6, 8, and 10 wt. %. Thereafter the torque was increased towards the target rate of 60 RPM in the following increments 20, 30, 40, 50, 60 RPM. At each stage the torque was allowed to stabilize for about 1 minute. Until the torque stabilized at a rotor speed of 60 RPM for 5 minutes, the whole process from adding the polymer typically took about 12-15 minutes, indicating the material was well mixed and the melt was close to the target temperature (265° C.), the required amount of pulverized additive polymer of Synthesis Example 6 was added without reducing the rotor speed. In each experiment in which additive was added, the torque fell rapidly, then rose and stabilized. After stabilizing, the experiment was continued for 5 minutes. At the end of the experiment, the rotor speed was reduced to 3 RPM and the immediately thereafter Haake bowl was removed while hot and the polymer inside removed and cooled while resting in air at room temperature. The material was removed from the bowl while still in a softened state and pressed in to slabs for storage in plastic packaging.

Each sample was molded on a Carver press model G302H-12-ASTM (Carver MPI, Wabash, Ind.) at 190° C. (temperature program: 6 mins at 20.7 MPa (3,000 psi), 4 mins at 207 MPa (30,000 psi), then cooled at 15° C./min to 35° C.) to form a bar having the nominal dimensions of 63.5 mm×12.7 mm×3.05 mm (2.5″×0.5″×0.120″) then subject to Dynamical Mechanical Spectroscopy (DMS) using an ARES LS Rheometer (TA Instruments, New Castle, Del., USA) at a frequency of 10 rad·sec and a torsion strain of 0.1%. Temperature was ramped at 5° C./min from −100° C. to a maximum of 250° C. or break, whichever came first. A 5 minute delay time was used to allow the sample to equilibrate to the −100° C. initial temperature.

The results are shown in Table 1, below, and reveal that Inventive Example 7-1 containing 2 wt. % polymer additive, based on total solids, was best compatibilized because the drop in G′ (storage modulus) was shifted to a higher temperature as the more temperature resistant component switched from a discrete to a continuous phase morphology. This change in morphology is an indication of mechanical coupling between the phases during blending. The preferred amount of polymer additive was less than 4% as amount of the additive greater than about 4% (Inventive Examples 7-2, 7-3, and 7-4) showed increase in torque. Comparative Example 7B, in which the additive was poly(meth(acrylic acid anhydride) comprised 66.7% anhydride and no ester showed a large increase in torque, indicative crosslinking of the polyester even though at the same concentration of additive as the in Inventive Example 7-2 and less than the other inventive examples.

TABLE 2
Dynamical Mechanical Spectroscopy Results
In the Table 2, below, T = Temp; G′ = Storage modulus.

| | Compar- | Inven- | Inven- | Inven- | Inven- | Compar- |
|---|---|---|---|---|---|---|
| | ative | tive | tive | tive | tive | ative |
| EXPT# | 7A | 7-1 | 7-2 | 7-3 | 7-4 | 7B |
| Additive | None | | | | | PMAAn* |
| | | | | | | 66.7 |
| | | | | | | wt. % |
| Amount of | 0 | 2 | 4 | 8 | 16 | 2 |
| additive | | | | | | |
| (%) | | | | | | |
| T (C.) at | 83.2 | 91.6 | 84.4 | 83.7 | 87.0 | 88.1 |
| G′ = | | | | | | |
| 1.0E+08 | | | | | | |
| MPa | | | | | | |
| T(C.) at | 117.6 | 124.7 | 114.6 | 113.4 | 112.4 | 118.8 |
| G′ = | | | | | | |
| 1.0E+07 | | | | | | |
| MPa | | | | | | |
| Final | 469 | 183 | 499 | 459 | 571 | 948 |
| torque | | | | | | |
| (mg) | | | | | | |

*Polymer of Synthesis Example 5 - 66.7 wt. % methacrylic anhydride groups in polymerized form, based on the total weight of methacrylic acid polymerized units in the polymer.

As shown in Table 2, above, the mechanical coupling of polymer phases reinforced the softened polyethylene phase and delays the drop in storage modulus to a higher temperature. The drop in storage modulus also shifted to a higher temperature as the more temperature resistant polyethylene terephthalate (polyester component) switched from a discrete to a continuous phase morphology. The results are confirmed by AFM images taken from microtomed sections of compression molded plaques of each tested blend, taken at room temperature. The final torque data shows that a 2 wt. % loading of the additive results in substantially less crosslinking of the polyester component than the comparative Examples, especially the pMAAn in Comparative Example 7B. This 2 wt. % loading is in the preferred range of additive proportions.

1. An amphiphilic comb polymer composition comprising one or more phosphorus acid group containing backbone polymers of methacrylic anhydride having hydrophobic ester or amide side chains formed on the backbone polymers, wherein the backbone polymer comprises from 75 to 100 wt. %, based on the total weight of monomers used to make the backbone polymer, of methacrylic acid polymerized units, and, further wherein, in the backbone polymer from 20 to less than 70 wt. % of the methacrylic acid polymerized units comprise methacrylic anhydride groups as acid polymerized units, all methacrylic anhydride percentages as determined by titration of the backbone polymer prior to the formation of any ester or amide side chains

2. The amphiphilic comb polymer composition as claimed in claim 1, wherein at least one of the one or more phosphorus acid group containing backbone polymers of methacrylic anhydride having hydrophobic ester or amide side chains comprises from 90 to 100 wt. %, based on the total weight of monomers used to make the backbone polymer, of methacrylic acid polymerized units.

3. The amphiphilic comb polymer composition as claimed in claim 1, wherein in at least one of the one or more phosphorus acid group containing backbone polymers of methacrylic anhydride having hydrophobic ester or amide side chains, from 50 to 67 wt. % of the methacrylic acid polymerized units in the backbone polymer comprises methacrylic anhydride as acid polymerized units, all methacrylic anhydride percentages as determined by titration.

4. The amphiphilic comb polymer composition as claimed in claim 1, wherein at least one of the one or more the phosphorus acid group containing backbone polymers in the amphiphilic comb polymers have a weight average molecular weight (Mw) of from 1,000 to 25,000.

5. The amphiphilic comb polymer composition as claimed in claim 1, wherein at least one of the one or more phosphorus acid group containing backbone polymers in the amphiphilic comb polymers comprise from 2 to 20 wt. %, of a phosphite compound, a hypophosphite compound or its salts, based on the total weight of reactants used to make the backbone polymer.

6. The amphiphilic comb polymer composition as claimed in claim 1, wherein the hydrophobic side chains are chosen from compounds having an average of from 1 to 500 carbons, cycloaliphatic hydrocarbons having an average of from 1 to 500 carbons, aryl hydrocarbons having an average of from 1 to 500 carbons, polyolefins, and their combinations, linked to the backbone polymer via an ester or amide group.

7. The amphiphilic comb polymer composition as claimed in claim 1, wherein the phosphorus acid group containing backbone polymers of methacrylic anhydride having hydrophobic side chains comprises powders, pellets, granules, or suspensions thereof in non-aqueous carriers, such as oils, e.g., vegetable oils, glycols, polyglycols, ethers, glycol ethers, glycol esters and alcohols.

8. The amphiphilic comb polymer composition as claimed in claim 1, further comprising one or more polyolefins, copolymers of polyethylene, or thermoplastic polyolefins (TPO).

9. The amphiphilic comb polymer composition as claimed in claim 8, further comprising an acrylic emulsion polymer, a polyamide polymer, a polyester polymer or a copolymer comprising vinyl alcohol.

10. The amphiphilic comb polymer composition as claimed in claim 8, wherein the compositions comprise from 0.1 to 35 wt. % in total of the one or more phosphorus acid group containing backbone polymers of methacrylic anhydride having hydrophobic side chains and one or more hydrophobic group containing alcohol or amine compound.

11. A method for making amphiphilic comb polymers of phosphorus acid group, containing backbone polymers of methacrylic anhydride having hydrophobic ester or amide side chains comprising:
aqueous solution polymerizing a monomer mixture of one or more phosphorus acid compound and/or its salt and methacrylic acid and/or its salt to form a precursor backbone polymer having methacrylic acid polymerized units;
drying the precursor backbone polymer at from 175 to 250° C. to form a melt of the backbone polymer of methacrylic anhydride; and,
grafting one or more hydrophobic group containing alcohol or amine compound onto the backbone polymer, the alcohol or amine compound chosen from a C₁ to C₅₀₀ alkyl group containing alcohol compound, a C₁ to C₅₀₀ alkyl group containing amine compound, a C₁ to C₅₀₀ cycloaliphatic group containing alcohol compound, a C₁ to C₅₀₀ cycloaliphatic group containing amine compound, a C₁ to C₅₀₀ alkyl aryl group containing alcohol compound, a C₁ to C₅₀₀ alkyl aryl group containing amine compound, a polyolefin alcohol compound, and a polyolefin amine compound, to form hydrophobic ester or amide side chains.
